(19) United States
(12) Patent Application Publication
(10) Pub. No.: US 2006/0052444 A1
(43) Pub. Date: Mar. 9, 2006

(54) Arthropod controlling agent

(75) Inventors: Toshio Igarashi, Kyoto-shi (JP); Keisuke Watanabe, Ashiya-shi (JP); Tomonori Iwasaki, Sanda-shi (JP)

Correspondence Address: BIRCH STEWART KOLASCH & BIRCH, PO BOX 747, FALLS CHURCH, VA, 22040-0747, US

(73) Assignees: Sumitomo Chemical Company, Limited; Sumika Life-Tech Co., Ltd.

(21) Appl. No.: 11/220,704

(22) Filed: Sep. 8, 2005

(30) Foreign Application Priority Data
Sep. 9, 2004 (JP) 2004-261959
Nov. 8, 2004 (JP) 2004-323195
Feb. 17, 2005 (JP) 2005-040276
May 20, 2005 (JP) 2005-147666

(51) Int. Cl. A01N 53/00

(52) U.S. Cl. 514/531

(57) ABSTRACT

The present invention aims to provide an arthropod controlling agent which rapidly exerts its efficacy against arthropods such as mosquitoes by simple installation in a place where arthropods inhabit and/or invade at room temperature. The arthropod controlling agent comprises an ester compound represented by the following formula (1): 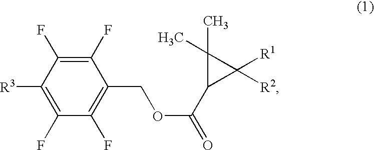
wherein R¹ denotes a hydrogen atom or methyl, R² denotes methyl or CH═CR²¹R²² wherein R²¹ and R²² independently denote a hydrogen atom or methyl, and R³ denotes a hydrogen atom, methyl or methoxymethyl, and said ester compound is supported on a polyolefin type resin, wherein the polyolefin type resin contains carboxylic acid ester monomer units in an amount of 1 to 10% by weight based on the entire arthropod controlling agent.

### BACKGROUND OF THE INVENTION

The present invention relates to arthropod controlling agents, in particular, arthropod controlling agents comprising an arthropod controlling active ingredient supported on a resin.

Ester compounds represented by the following formula (1): 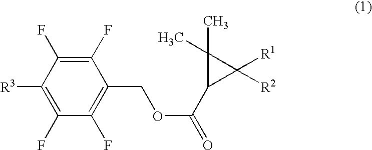
wherein
R¹ denotes a hydrogen atom or methyl,
R² denotes methyl or CH═CR²¹R²² wherein R²¹ and R²² independently denote a hydrogen atom or a methyl,
R³ denotes a hydrogen atom, methyl or methoxymethyl, have been known as active ingredients of arthropod controlling agents (see e.g. U.S. Pat. No. 6,225,495B1, U.S. Pat. No. 6,294,576B1, EP0 060 617A1, JP-A 2001-302590).

An arthropod controlling agent for a septic tank comprising an arthropod controlling active ingredient supported on an organic polymer have been also known well (see JP-A 2002-114613).

However, the arthropod controlling agent for a septic tank disclosed in JP-A 2002-114613 does not necessarily have sufficient efficacy in terms of immediate effect or residual effect. Therefore, there is a need for arthropod controlling agents which rapidly exert their efficacy against arthropods and retains the efficacy for a long time.

### SUMMARY OF THE INVENTION

The present invention provides arthropod controlling agents which comprise an arthropod controlling active ingredient supported on a resin and which rapidly exert their efficacy against arthropods and retains the efficacy for a long time. That is, the present invention is as follows:

[1] An arthropod controlling agent which comprises an ester compound represented by the following formula (1): 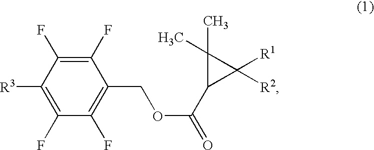
wherein
R¹ denotes a hydrogen atom or methyl, R denotes methyl or CH═CR²¹R²² wherein R²¹ and R²² independently denote a hydrogen atom or methyl, and
R³ denotes a hydrogen atom, methyl or methoxymethyl, and said ester compound is supported on a polyolefin type resin, wherein the polyolefin type resin contains carboxylic acid ester monomer units in an amount of 1 to 10% by weight based on the entire arthropod controlling agent;

[2] The arthropod controlling agent according to the above [1], wherein the weight ratio of the ester compound represented by the formula (1) and the carboxylic acid ester monomer units is in the range from 3:1 to 1:3;

[3] The arthropod controlling agent according to the above [1] or [2], which contains 0.1 to 20% by weight of the ester compound represented by the formula (1) based on entire amount of the arthropod controlling agent;

[4] The arthropod controlling agent according to any one of above [1] to [3], wherein the polyolefin type resin is a polyethylene type resin;

[5] The arthropod controlling agent according to any one of above [1] to [4], wherein the carboxylic acid ester monomer is unsaturated carboxylic acid ester or vinyl carboxylate;

[6] The arthropod controlling agent according to any one of above [1] to [4], wherein the carboxylic acid ester monomer is methyl acrylate, methyl methacrylate or vinyl acetate;

[7] The arthropod controlling agent according to any one of above [1] to [4], wherein the carboxylic acid ester monomer is methyl methacrylate;

[8] The arthropod controlling agent according to any one of above [1] to [3], wherein the polyolefin type resin is a resin containing an ethylene-methyl methacrylate copolymer;

[9] The arthropod controlling agent according to any one of above [1] to [3], wherein the polyolefin type resin is a polymer blend of polyethylene and an ethylene-methyl methacrylate copolymer;

[10] The arthropod controlling agent according to any one of above [1] to [9], which comprises the ester compound represented by the formula (1) wherein
R¹ denotes a hydrogen atom,
R² denotes CH═CR²¹R²² wherein R²¹ and R²² independently denote a hydrogen atom or methyl, and
R³ denotes a hydrogen atom, methyl or methoxymethyl;

[11] The arthropod controlling agent according to any one of above [1] to [10], wherein the ester compound represented by the formula (1) is selected from the group consisting of
2,3,5,6-tetrafluoro-4-methoxymethylbenzyl 3-(1-propenyl)-2,2-dimethylcyclopropanecarboxylate,
2,3,5,6-tetrafluoro-4-methylbenzyl 3-(1-propenyl)-2,2-dimethylcyclopropanecarboxylate,
2,3,5,6-tetrafluoro-4-methoxymethylbenzyl 3-(2-methyl-1-propenyl)-2,2-dimethylcyclopropanecarboxylate,
2,3,5,6-tetrafluoro-4-methoxymethylbenzyl 2,2,3,3-tetramethylcyclopropanecarboxylate,
2,3,5,6-tetrafluoro-4-methylbenzyl 2,2,3-trimethylcyclopropanecarboxylate,
2,3,5,6-tetrafluoro-4-methoxymethylbenzyl 1R-trans-3-(1-propenyl)-2,2-dimethylcyclopropanecarboxylate,
2,3,5,6-tetrafluoro-4-methylbenzyl 1R-trans-3-(1-propenyl)-2,2-dimethylcyclopropanecarboxylate,
2,3,5,6-tetrafluoro-4-methoxymethylbenzyl 1R-trans-3-(2-methyl-1-propenyl)-2,2-dimethylcyclopropanecarboxylate,
2,3,5,6-tetrafluoro-4-methylbenzyl 1R-trans-2,2,3-trimethylcyclopropanecarboxylate,
2,3,5,6-tetrafluoro-4-methoxymethylbenzyl 1R-trans-3-(1-propenyl (E/Z=1/8))-2,2-dimethylcyclopropanecarboxylate, and
2,3,5,6-tetrafluoro-4-methylbenzyl 1R-trans-3-(1-propenyl(E/Z=1/8))-2,2-dimethylcyclopropanecarboxylate;

[12] The arthropod controlling agent according to any one of above [1] to [11], wherein one or more opening parts are present and the opening rate is 50 to 90%;

[13] The arthropod controlling agent according to any one of above [1] to [12], which is effective against mosquitoes;

[14] A method for controlling arthropods which comprises installing the arthropod controlling agent according to any one of above [1] to [13] in a place where arthropods inhabit or invade;

[15] The method according to the above [14], wherein the place where arthropods inhabit or invade is the entrance of a house, a garden, a living room, a balcony and a porch, or the inside of a drawer or a closet;

[16] The method according to the above [14], wherein the place where arthropods inhabit or invade is a place where a domestic animal or a pet is kept; and

[17] A method for controlling arthropods which comprises attaching the arthropod controlling agent according to any one of above [1] to [13] to a part of the body surface of a warm-blooded animal.

The arthropod controlling agent of the present invention is characterized in that it comprises an ester compound represented by the formula (1) supported on a polyolefin type resin and the polyolefin type resin contains carboxylic acid ester monomer units in an amount of 1 to 10% by weight based on the entire arthropod controlling agent.

### BRIEF DESCRIPTION OF THE DRAWINGS

FIG. 1 is a perspective view showing an example of cylindrical arthropod controlling agents of the present invention.

FIG. 2 is a top view showing an example of sheet-like arthropod controlling agents of the present invention.

FIG. 3 illustrates methods of installing the arthropod controlling agent of the present invention shown in FIG. 1 or 2 in a balcony. FIG. 3(a) is a front view showing the arthropod controlling agent attached to a laundry pole via a hanging tool. FIG. 3(b) is a front view showing the arthropod controlling agent attached directly to a laundry pole.

FIG. 4 is a perspective view showing a method of installing arthropod controlling agents of the present invention in a wardrobe or a closet.

FIG. 5 is a front view showing an example of using the arthropod controlling agents of the present invention shown in FIG. 2 in the form of a flag.

FIG. 6 is a front view showing another example of using the arthropod controlling agents of the present invention shown in FIG. 2 in the form of a flag.

FIG. 7 is a top view showing an example of lattice-like arthropod controlling agents of the present invention.

FIG. 8 is a perspective view showing an example of installing the arthropod controlling agents of the present invention shown in FIG. 2 or 7 in a drawer.

FIG. 9(a) is a front view showing the lattice-like arthropod controlling agent of the present invention shown in FIG. 7 put in a case and FIG. 9(b) shows the arthropod controlling agent pulled out of the case.

FIG. 10 is a perspective view showing an example of installing the arthropod controlling agent of the present invention put in a case shown in FIG. 9 in a kennel.

FIG. 11 is a perspective view showing examples of installing an arthropod controlling agent of the present invention in a kennel.

FIG. 12 is a perspective view showing an example of installing an arthropod controlling agent of the present invention in a kennel.

FIG. 13 is a front view showing an example of arthropod controlling agents of the present invention.

FIG. 14 is a perspective view showing an example of installing an arthropod controlling agent of the present invention in a kennel.

FIG. 15 is a perspective view showing an example of installing arthropod controlling agents of the present invention in a livestock shed.

FIG. 16 is a front view showing an example of attaching an arthropod controlling agent of the present invention to the waist.

FIG. 17 is a front view showing an example of attaching an arthropod controlling agent of the present invention to the wrist.

FIG. 18 is a front view showing an example of attaching an arthropod controlling agent of the present invention to the ankle.

FIG. 19 shows a front view (upper figure) of a bandanna-like shaped arthropod controlling agent of the present invention which is prepared by cutting out of a sheet-like arthropod controlling agent of the present invention and a side view (lower figure) showing an example of attaching the bandanna-like shaped arthropod controlling agent to a dog.

FIG. 20 is a side view showing an example of dressing a dog in an arthropod controlling agent of the present invention in the form of clothing prepared by sewing.

FIG. 21 shows a front view (left figure) showing an example of using an arthropod controlling agent of the present invention as parts of a balancing toy and a front view (right drawing) showing another example.

FIG. 22 is a side view showing an example of using an arthropod controlling agent of the present invention as the instep part of a slipper.

FIG. 23 shows a perspective view (left figure) showing an example of attaching an arthropod controlling agent of the present invention to the outer periphery of a flowerpot and a perspective view (right drawing) showing another example.

FIG. 24 is a front view of a wind-bell made by attaching a rectangular arthropod controlling agent of the present invention to a bell.

FIG. 25 shows a perspective view (left figure) of a key holder made of an arthropod controlling agent of the present invention and a perspective view (right figure) of another example.

FIG. 26 is a front view showing a hanging scroll made by attaching a housing part and a fixing part such as a hook to an arthropod controlling agent of the present invention.

FIG. 27 is a front view of a lattice-like arthropod controlling agent of the present invention to which a hook-like hanging tool is attached.

FIG. 28 shows a perspective view (a) and a perspective view of the reverse side thereof (b) of a suitably-shaped arthropod controlling agent of the present invention to which a part for fixing on a plane is attached, a perspective view (c) of another example, and a front view (d) showing an example of sticking the arthropod controlling agents on a window.

### DETAILED DESCRIPTION OF THE EMBODIMENTS

The ester compound represented by the formula (1) used in the present invention is described in EP0060617, U.S. Pat. No. 6,225,495B1, U.S. Pat. No. 6,294,576B1, JP-A 7-17916 etc. and can be produced by methods described in these publications.

The ester compound represented by the formula (1) has isomers based on the asymmetric carbon atom and also has isomers based on the carbon-carbon double bond. Any active isomers can be used for the present invention.

Examples of the ester compound represented by the formula (1) include 2,3,5,6-tetrafluoro-4-methoxymethylbenzyl 3-(1-propenyl)-2,2-dimethylcyclopropanecarboxylate, 2,3,5,6-tetrafluoro-4-methylbenzyl 3-(1-propenyl)-2,2-dimethylcyclopropanecarboxylate, 2,3,5,6-tetrafluoro-4-methoxymethylbenzyl 3-(2-methyl-1-propenyl)-2,2-dimethylcyclopropanecarboxylate, 2,3,5,6-tetrafluoro-4-methoxymethylbenzyl 2,2,3,3-tetramethylcyclopropanecarboxylate, 2,3,5,6-tetrafluoro-4-methylbenzyl 2,2,3-trimethylcyclopropanecarboxylate, 2,3,5,6-tetrafluoro-4-methoxymethylbenzyl 1R-trans-3-(1-propenyl)-2,2-dimethylcyclopropanecarboxylate, 2,3,5,6-tetrafluoro-4-methylbenzyl 1R-trans-3-(1-propenyl)-2,2-dimethylcyclopropanecarboxylate, 2,3,5,6-tetrafluoro-4-methoxymethylbenzyl 1R-trans-3-(2-methyl-1-propenyl)-2,2-dimethylcyclopropanecarboxylate, 2,3,5,6-tetrafluoro-4-methylbenzyl 1R-trans-2,2,3-trimethylcyclopropanecarboxylate, 2,3,5,6-tetrafluoro-4-methoxymethylbenzyl 1R-trans-3-(1-propenyl(E/Z=1/8))-2,2-dimethylcyclopropanecarboxylate, and 2,3,5,6-tetrafluoro-4-methylbenzyl 1R-trans-3-(1-propenyl(E/Z=1/8))-2,2-dimethylcyclopropanecarboxylate.

A polyolefin type resin used for the arthropod controlling agent of the present invention contains carboxylic acid ester monomer units in an amount of 1 to 10% by weight based on the entire arthropod controlling agent. A polyolefin type resin means a resin containing olefin monomers as the main monomer component.

Examples of the polyolefin type resin used for the present invention include polyethylene type resins and polypropylene type resins. A polyethylene type resin means a resin containing ethylene monomers as the main monomer component. A polypropylene type resin means a resin containing propylene monomers as the main monomer component.

A carboxylic acid ester monomer, as used in the present invention, means unsaturated carboxylic acid ester or vinyl carboxylate.

Examples of the unsaturated carboxylic acid ester include lower alkyl acrylate such as methyl acrylate, ethyl acrylate and butyl acrylate, and lower alkyl methacrylate such as methyl methacrylate, ethyl methacrylate and butyl methacrylate. Examples of the vinyl carboxylate include lower fatty acid vinyl ester such as vinyl acetate.

The polyolefin type resin used in the present invention may consist of a single copolymer, or may be a polymer blend consisting of two or more polymers and/or copolymers. That is, the polyolefin type resin used in the present invention may be a polyolefin type copolymer as it is containing a suitable amount of carboxylic acid ester monomer units, or may be a polymer blend which is prepared by mixing a polyolefin type copolymer containing a large quantity of carboxylic acid ester monomer units (e.g. a polyolefin type copolymer containing 10 to 40% by weight of carboxylic acid ester monomer units) with an olefin homopolymer so that the resulting polymer blend contains a suitable amount of carboxylic acid ester monomer units.

Examples of such a polyolefin type copolymer containing carboxylic acid ester monomer units include polyethylene type copolymers containing carboxylic acid ester monomer units and polypropylene type copolymers containing carboxylic acid ester monomer units. A polyolefin type copolymer as used in the present invention means a polymer comprising olefin monomers as the main monomer component and carboxylic acid ester monomers as other monomer components.

Examples of the polyethylene type copolymer containing carboxylic acid ester monomer units include ethylene-methyl acrylate copolymers, ethylene-ethyl acrylate copolymers, ethylene-butyl acrylate copolymers, ethylene-methyl methacrylate copolymers and ethylene-ethyl methacrylate copolymers.

Examples of the polypropylene type copolymer containing carboxylic acid ester monomer units include propylene-methyl acrylate copolymers, propylene-ethyl acrylate copolymers, propylene-butyl acrylate copolymers, propylene-methyl methacrylate copolymers and propylene-ethyl methacrylate copolymers.

These polymers can be produced from monomers by well-known polymerization methods using a well-known radical polymerization catalyst or an ion polymerization catalyst. Examples of the well-known catalyst include peroxide catalysts, Ziegler-Natta catalysts, metallocene catalysts, and the like. Examples of the well-known polymerization method include solution polymerization, slurry polymerization, high-pressure ion polymerization, high-pressure radical polymerization and vapor-phase polymerization.

When the polyolefin type resin used in the present invention is a polymer blend which is prepared by mixing a polyolefin type polymer containing a large quantity of carboxylic acid ester monomer units and an olefin homopolymer so that the resulting polymer blend contains a suitable amount of carboxylic acid ester monomer units, examples of the polymer blend include a polymer blend of ethylene-methyl acrylate and polyethylene, a polymer blend of ethylene-ethyl acrylate and polyethylene, a polymer blend of ethylene-methyl methacrylate and polyethylene, and a polymer blend of ethylene-ethyl methacrylate and polyethylene.

In the arthropod controlling agent of the present invention, an ester compound represented by the formula (1) is present at a weight ratio of the ester compound represented by the formula (1) to carboxylic acid ester monomer units in a polyolefin type resin of usually 3:1 to 1:3, preferably 2:1 to 1:2.

The amount of an ester compound represented by the formula (1) contained in the arthropod controlling agent of the present invention is usually 0.1 to 20% by weight, preferably 0.1 to 10% by weight, more preferably 0.5 to 7.0% by weight.

The arthropod controlling agent of the present invention may contain a UV absorbent, if necessary.

Examples of such an UV absorbent include phenyl salicylate; benzophenone compounds such as 2,4-dihydroxybenzophenone, 2-hydroxy-4-methoxybenzophenone, and 2-hydroxy-4-n-octylbenzophenone; benzotriazole compounds such as 2-(2-hydroxy-5-methylphenyl)benzotriazole, 2-[2-hydroxy-3-(3,4,5,6-tetrahydrophthalimido-methyl)-5-methylphenyl]benzotriazole, 2-(3-tert-butyl-2-hydroxy-5-methylphenyl)-5-chlorobenzotriazole, 2-(2-hydroxy-5-tert-octylphenyl)benzotriazole, and 2-(2-hydroxy-3,5-di-tert-pentylphenyl)benzotriazole; and benzoate compounds such as 2,4-di-tert-buthylphenyl 3,5-di-tert-buthyl-4-hydroxybenzoate. Preferred are benzophenone compounds and benzotriazole compounds. When the arthropod controlling agent of the present invention contains the UV absorbent, the content is usually 0.005 to 5% by weight.

The arthropod controlling agent of the present invention may further contain an antioxidant, a pigment and the like, if necessary.

Examples of such an antioxidant include butyl hydroxyanisole (BHA), stearyl β-(3,5-di-tert-butyl-4-hydroxyphenyl)propionate, 4,4′-thiobis(3-methyl-6-t-butylphenol) (TBMTBP), and triphenylphosphite.

The arthropod controlling agent of the present invention is produced by, for example, mixing and kneading an ester compound represented by the formula (1) and a polyolefin type resin containing a prescribed amount of carboxylic acid ester monomer units, and shaping the obtained kneaded mixture by a molding method usually used for thermoplastic resins (e.g., extrusion molding, calender molding, blow molding, vacuum molding, injection molding, rotation molding, etc.).

The molded body thus obtained may be subjected to secondary processing such as slitting, slicing, and pelletizing to change the shape, and then may be used as the arthropod controlling agent of the present invention.

The step of mixing and kneading an ester compound represented by the formula (1) and a polyolefin type resin containing a prescribed amount of carboxylic acid ester monomer units includes a step of mixing and kneading an ester compound represented by the formula (1), a polyolefin type resin containing a large quantity of carboxylic acid ester monomer units, and an olefin homopolymer; and a step of mixing and kneading an olefin homopolymer with a kneaded mixture of an ester compound represented by the formula (1) and a polyolefin type resin containing a large quantity of carboxylic acid ester monomer units.

The form of the arthropod controlling agent of the present invention thus produced includes, for example, a film form, a sheet form, a plate form, a fibrous form, a net-like form, a lattice-like form, a granular form, and the like.

The arthropod controlling agent of the present invention is used, for example, by installation in a place where arthropods inhabit or invade, or the like. The amount used of the arthropod controlling agent of the present invention is usually 0.01 to 30 g, preferably 0.1 to 30 g of an ester compound represented by the formula (1) per 1 m³ of the space to be protected from arthropods.

Installation of the arthropod controlling agent of the present invention is accomplished, for example, by putting it on a floor, laying it on a floor, suspending it from a ceiling, or sticking it on a wall.

After the arthropod controlling agent of the present invention is installed, in the installation place, the active ingredient an ester compound represented by the formula (1) is gradually volatilized from the arthropod controlling agent of the present invention to exert arthropod-controlling effect. If the arthropod controlling agent of the present invention is installed in a well-ventilated place, the active ingredient an ester compound represented by the formula (1) is more efficiently volatilized to exert better arthropod-controlling effect. The arthropod controlling agent of the present invention is preferably installed on the relatively windward side in a place where arthropods inhabit or invade. The place where arthropods inhabit or invade includes, for example, livestock sheds such as a stable, a cowshed, a poultry house and a pigpen; pet houses such as a kennel and a rabbit hutch; places surrounding the doors, exhaust ports, electric lights and the like of a factory or a workshop; the outside of a house such as a balcony, a porch, and an entrance; storage spaces for clothes, such as the inside of a closet and the inside of a drawer; the interior spaces of a house such as a bedroom, a living room and a kitchen; the inside of a septic tank; the back of a manhole cover; the exit, periphery and inside of a tent in a camping area or a park; and places for outdoor activity such as barbecue, fishing, hiking, gardening and the like, and their surroundings.

In terms of the volatilization efficiency of an ester compound represented by the formula (1), the arthropod controlling agent of the present invention preferably has one or more opening parts formed by molding, perforating or the like. The arthropod controlling agent of the present invention has an opening rate of preferably 50 to 90%, more preferably 60 to 85%. The term “opening rate”, as used herein, means the percentage of the total surface area of opening parts in the surface area of the arthropod controlling agent. In terms of productivity, the arthropod controlling agent of the present invention is preferably in the net-like or lattice-like form having the above-mentioned opening rate, or a secondarily processed product of the net-like or lattice-like shaped product.

The arthropod controlling agent of the present invention can be also attached to a part of the body surface of a warm-blooded animal (e.g., a pet such as a dog, a cat or a rabbit; a domestic animal such as a horse, a caw, a chicken or a pig, or a human) or to clothes or the like covering a part of the body surface to protect the warm-blooded animal from harmful action by arthropods, in particular, blood-sucking action of mosquitoes. Attachment of the arthropod controlling agent of the present invention is accomplished, for example, by hanging the agent from the waist using a string; winding the agent around the ankle, wrist, arm, body or the like using a suitable fastening tool or the like; cutting and sewing the agent to prepare clothing and then dressing the animal in it; or the like. In these cases, the amount used of the arthropod controlling agent of the present invention can be selected appropriately depending on targeted arthropods, use duration, and the like. It is usually 0.001 to 10 mg, preferably 0.01 to 5 mg, more preferably 0.05 to 2.5 mg of an ester compound represented by the formula (1) per 1 cm² of the body surface of a warm-blooded animal to be protected from harmful action of arthropods.

Examples of the shape of the arthropod controlling agent of the present invention and examples of specific methods of using it are as follows.

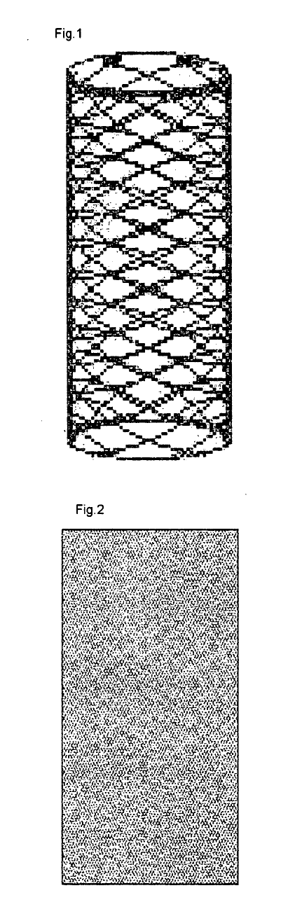

The shape of the arthropod controlling agent of the present invention includes, for example, a cylindrical shape (see FIG. 1) formed by mixing and kneading an ester compound represented by the formula (1) and a polyolefin type resin containing a prescribed amount of carboxylic acid ester monomer units, extrusion-molding the resulting kneaded mixture, and then cutting the molded product into the desired length; and a sheet-like shape (see FIG. 2) formed by cutting the above-described cylindrical-shaped product and then changing it into a sheet-like shape. The cylindrical or sheet-like arthropod controlling agent of the present invention may have opening parts and in this case, the agent has a net-like shape.

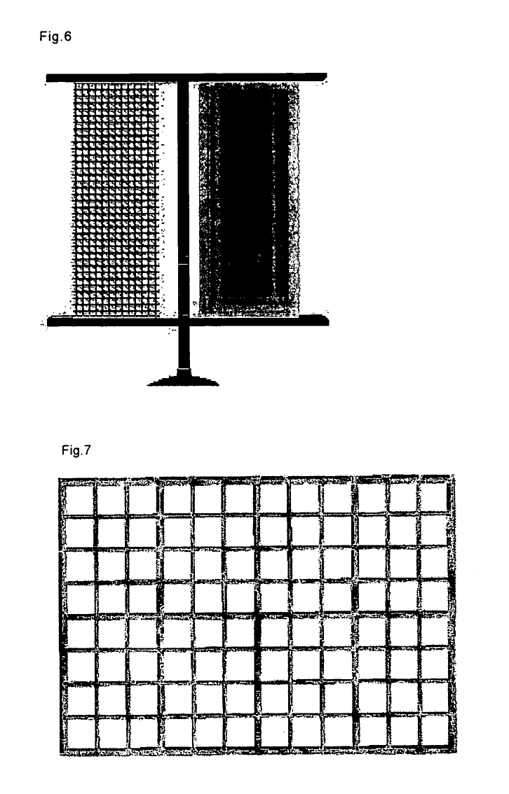

The shape of the arthropod controlling agent of the present invention further includes a lattice-like shape (see FIG. 7) formed by injection molding the above-described kneaded mixture.

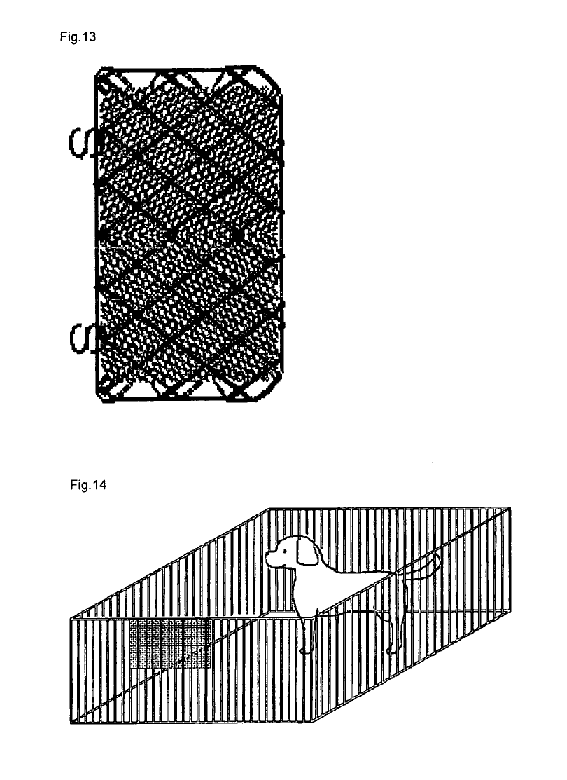

The arthropod controlling agents of the present invention having these shapes thus obtained can be further processed into optional shapes, and also can be wrapped with coarse nets made of plastics, metal or fiber (e.g., polyester, etc.) (see FIG. 13).

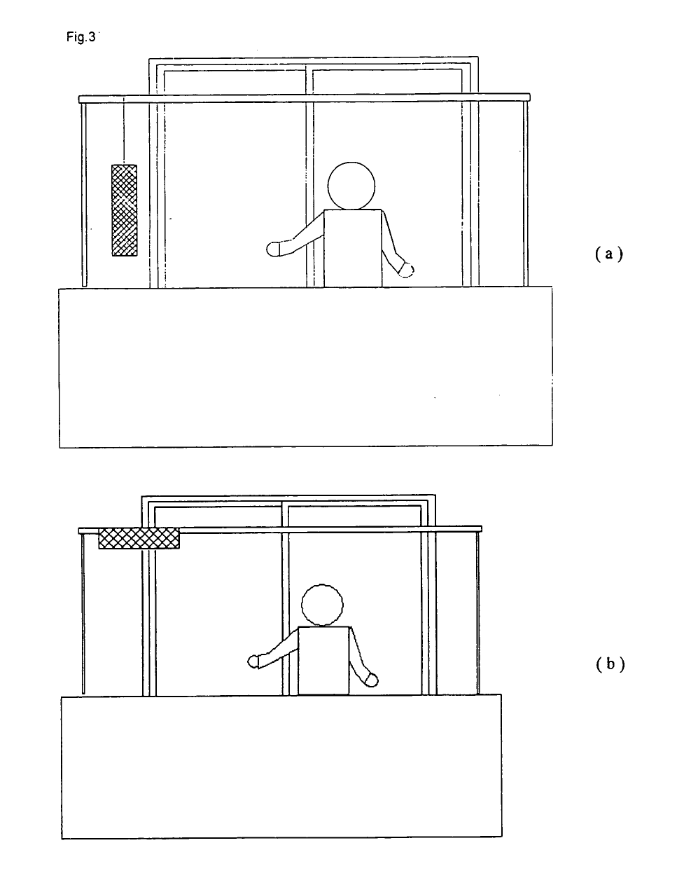

The cylindrical arthropod controlling agent of the present invention as shown in FIG. 1 can be, for example, installed in a balcony or a porch of a house using a string, a hanging tool or the like (see FIG. 3) to prevent arthropods from invading the inside of the house. The cylindrical arthropod controlling agent of the present invention as shown in FIG. 1 can be also installed in the inside of a space in which clothes are hung and stored, such as a closet or the like (see FIG. 4), to protect the clothes hung and stored in the inside of the space from damages by arthropods.

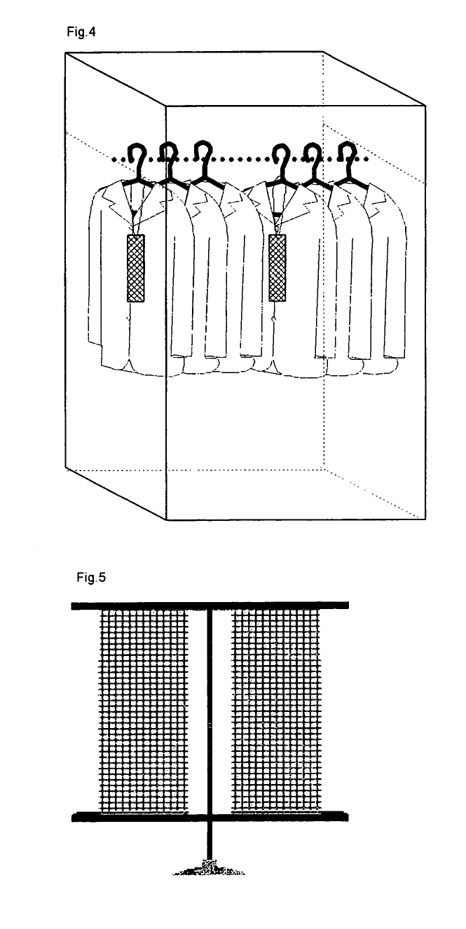

The sheet-like arthropod controlling agent of the present invention as shown in FIG. 2 can be used as a flag, for example, by using a sheet of the agent or by arranging two or more sheets of the agent (see FIG. 5).

In addition, the sheet-like arthropod controlling agent of the present invention as shown in FIG. 2 can be also used in combination with a pigment-containing resin that has an indicator function capable of showing the expiration of the efficacious period, wherein the indicator function is accomplished by the volatilization of the pigment synchronous with the volatilization of an ester compound represented by the formula (1), which is the active ingredient of the arthropod controlling agent of the present invention (see FIG. 6). That is, one or more sheets of the arthropod controlling agent of the present invention are installed as flags and at the same time, one or more plates of a resin bearing a pigment that volatilizes at the normal temperature are installed as flags. In this case, the indicator function showing the efficacious period of the arthropod controlling agent of the present invention can be provided by incorporating a pigment into a resin in such a manner that the pigment is volatilized from the resulting pigment-bearing resin synchronously with the volatilization of the arthropod-controlling active ingredient from the arthropod controlling agent of the present invention, and the resin is then discolored.

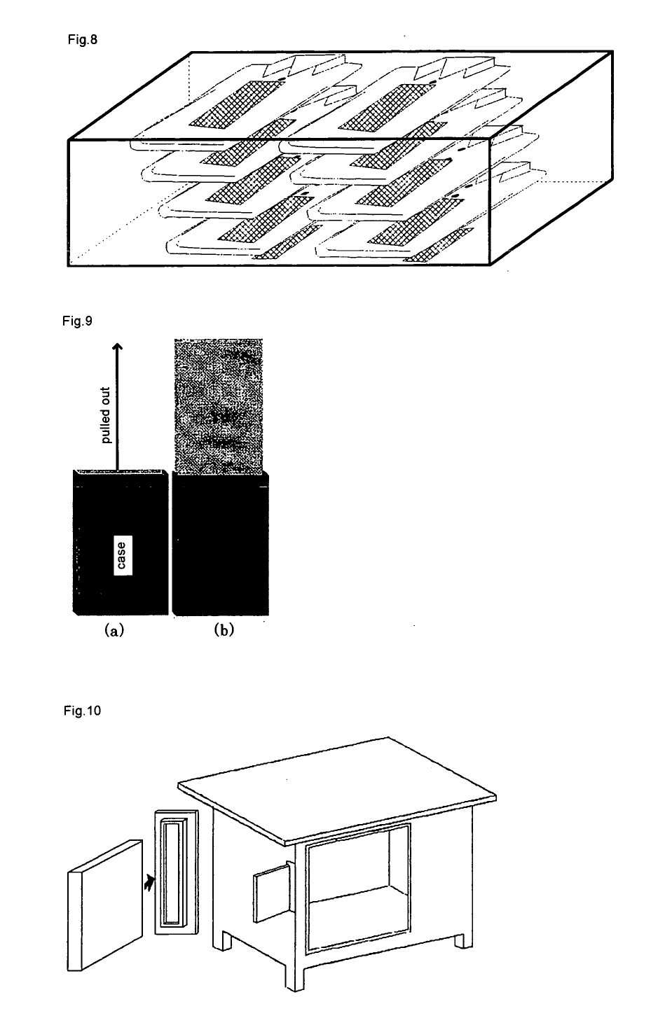

The lattice-like arthropod controlling agent of the present invention shown in FIG. 7 can be put in the inside of a space in which folded clothes are stored, such as a drawer or the like, to protect the stored clothes from damages by arthropods (see FIG. 8). The lattice-like arthropod controlling agent of the present invention shown in FIG. 7 can also be put in a plastic or metal case (see FIGS. 9(a) and 9(b)), attached to a kennel, a rabbit hutch or the like, and then pulled out of the case as need arises to enable the arthropod-controlling active ingredient to volatilize around the kennel, the rabbit hutch or the like and as a result, to prevent arthropods from invading the inside of the kennel, the rabbit hutch or the like (see FIG. 10). In FIG. 10, the arthropod controlling agent of the present invention put in a case as shown in FIG. 9 is attached near the entrance of a kennel, together with the case, via a device into which the case can be fitted. FIG. 10 shows a method of preventing arthropods from invading the inside of a kennel by pulling the arthropod controlling agent of the present invention out of the case appropriately in accordance with arthropod infestation.

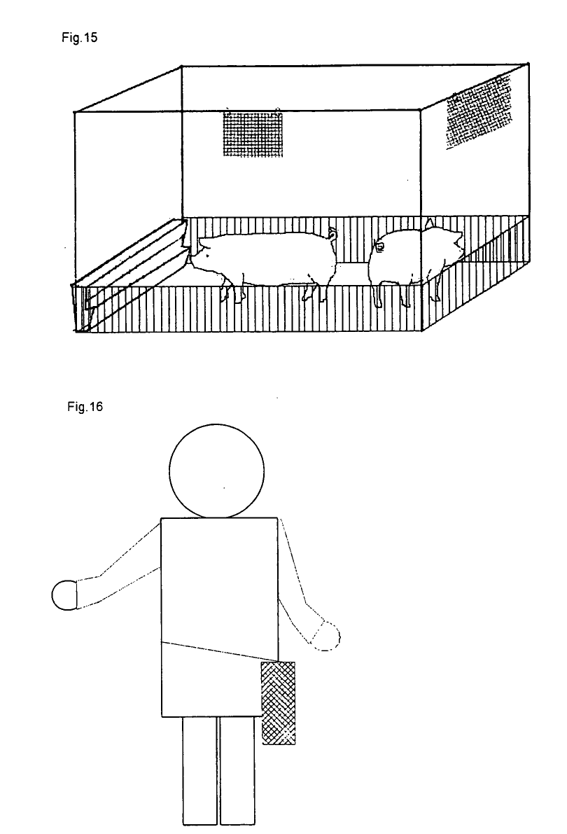

The arthropod controlling agent of the present invention in the form as shown in FIG. 1 or 2 or in the form wrapped with a net as shown in FIG. 13 can be hung near the entrance of a kennel via a suitable string, a hanging tool or the like to prevent the invasion of arthropods into the kennel (see FIGS. 11, 12 and 14). For a livestock shed such as a cowshed, a pigpen or a poultry house, one or more arthropod controlling agents of the present invention can be put in suitable places such as doors, windows, a roof, and the like (see FIG. 15) to prevent the invasion of arthropods.

FIG. 11 shows methods of preventing arthropods from inhabiting or invading the inside of a kennel by hanging the cylindrical arthropod controlling agent of the present invention shown in FIG. 1 (left figure) and by hanging the sheet-like arthropod controlling agent of the present invention shown in FIG. 2 (right figure).

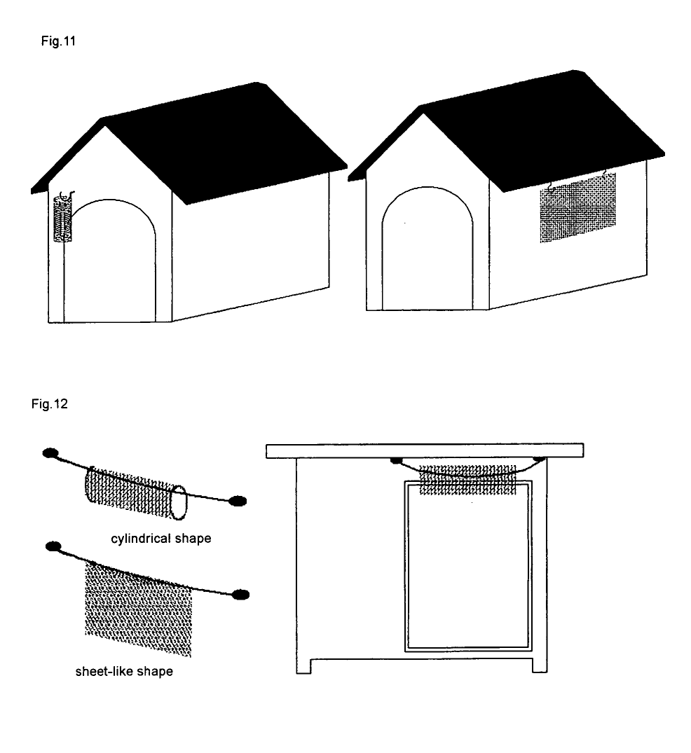

FIG. 12 shows a method of preventing arthropods from inhabiting or invading the inside of a kennel by hanging the cylindrical arthropod controlling agent of the present invention shown in FIG. 1 near the entrance of a kennel via a rope (left figure) or by hanging the sheet-like arthropod controlling agent of the present invention shown in FIG. 2 via a rope (right figure).

FIG. 14 shows a method of preventing arthropods from inhabiting or invading a space partitioned with a fence by hanging the arthropod controlling agent of the present invention on the fence.

FIG. 15 shows a method of preventing arthropods from inhabiting or invading the inside of a livestock shed by installing the arthropod controlling agents of the present invention near the roof of the livestock shed.

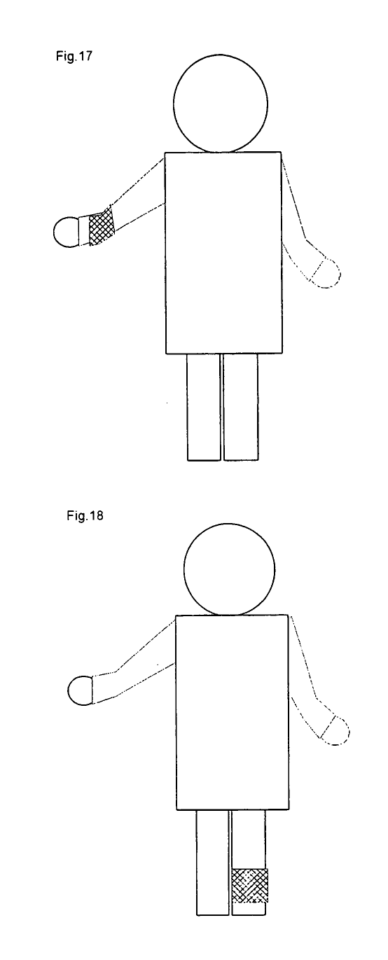

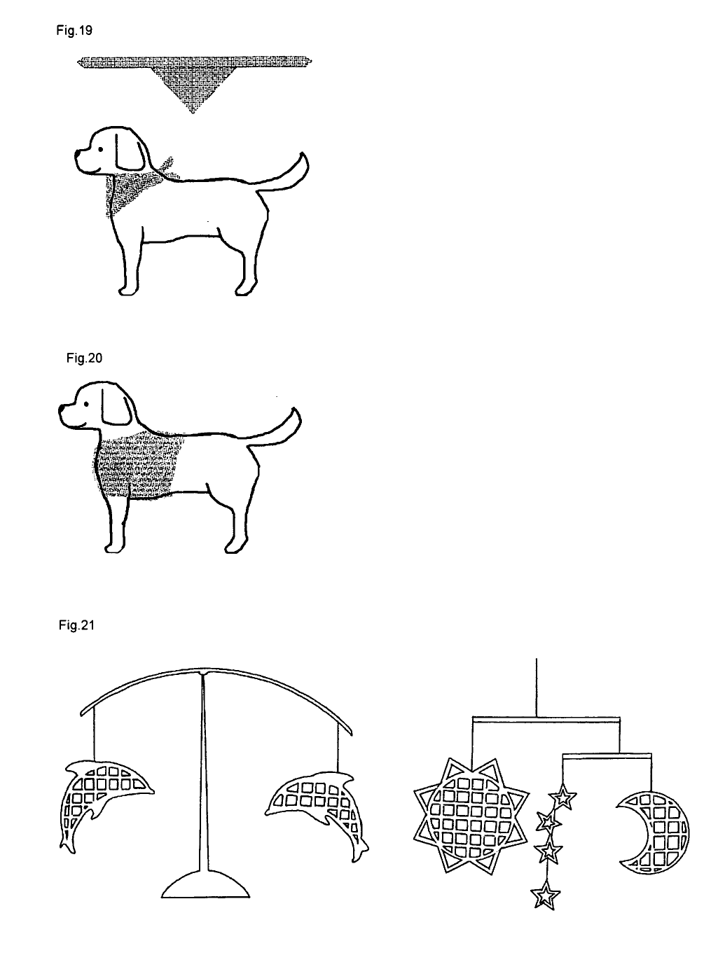

The arthropod controlling agent of the present invention may be processed appropriately so that it can be attached to a part of the body surface of a warm-blooded animal to protect the animal from harmful action by arthropods. In the case of a human, for example, the arthropod controlling agent of the present invention may be hung from the waist (see FIG. 16), wound around the wrist or the arm (see FIG. 17), or wound around the ankle (see FIG. 18). In the case of a pet such as a dog or a cat, for example, from the sheet-like arthropod controlling agent of the present invention as shown in FIG. 2 or the lattice-like arthropod controlling agent of the present invention as shown in FIG. 7, a bandanna-like shape may be cut out and then wound around the neck of a pet (see FIG. 19), or clothing may be sewed and then a pet may be dressed in it (see FIG. 20). When the arthropod controlling agent of the present is applied to a part of the body surface of a warm-blooded animal in this way, the warm-blooded animal can be protected from harmful action by arthropods, in particular, blood-sucking action of mosquitoes by attaching the agent to a part of the body surface or to clothes or the like covering a part of the body surface.

The arthropod controlling agent of the present invention can be formed into a suitable shape and then one or more pieces of the agent can be used as parts of a balancing toy (see FIG. 21). Such a balancing toy may be installed, for example, in the inside of a house to prevent arthropods from inhabiting or invading the inside of the house.

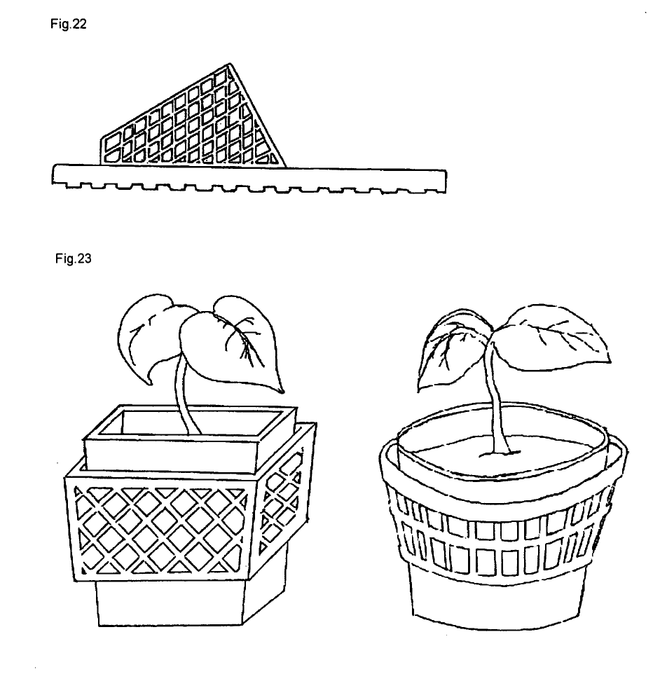

The arthropod controlling agent of the present invention can be formed into a shape suitable for the instep parts of slippers and attached to the bottom parts of the slippers (see FIG. 22). Such slippers may be used, for example, in a house to prevent harmful action by arthropods, in particular, blood-sucking action of mosquitoes.

The arthropod controlling agent of the present invention can be installed in the vicinity of a flowerpot to prevent arthropods from inhabiting or invading the flowerpot. Installation of the arthropod controlling agent of the present invention in the vicinity of a flowerpot is accomplished, for example, by forming the arthropod controlling agent of the present invention into a cylindrical shape corresponding to the shape of a flowerpot and then fitting the flowerpot in the inside of the cylinder (see FIG. 23), or by forming the arthropod controlling agent of the present invention into a belt-like shape, winding the belt-like agent around the outer periphery of a flowerpot and, if necessary, then fixing the belt-like agent with a suitable tool. These installation methods can be applied to not only a flowerpot but also any optional container for cultivation such as a planter.

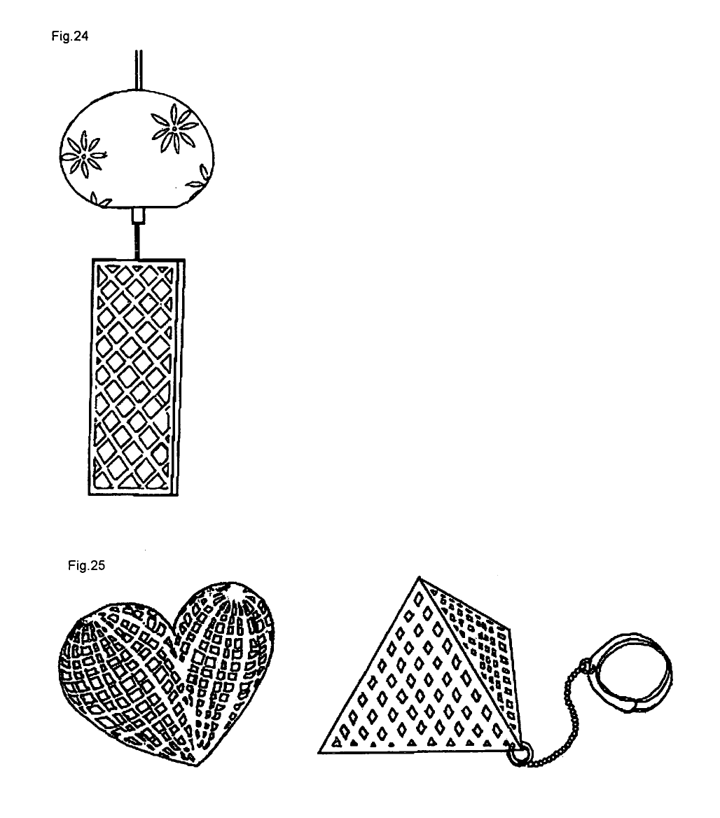

The arthropod controlling agent of the present invention can be formed into a rectangle and then connected to a bell with a hanging string to make a wind-bell (see FIG. 24). The wind-bell may be installed in the outside of a house to prevent arthropods from inhabiting or invading around the installation place. The arthropod controlling agent of the present invention can be formed into a shape suitable for a use as parts of a key holder (see FIG. 25).

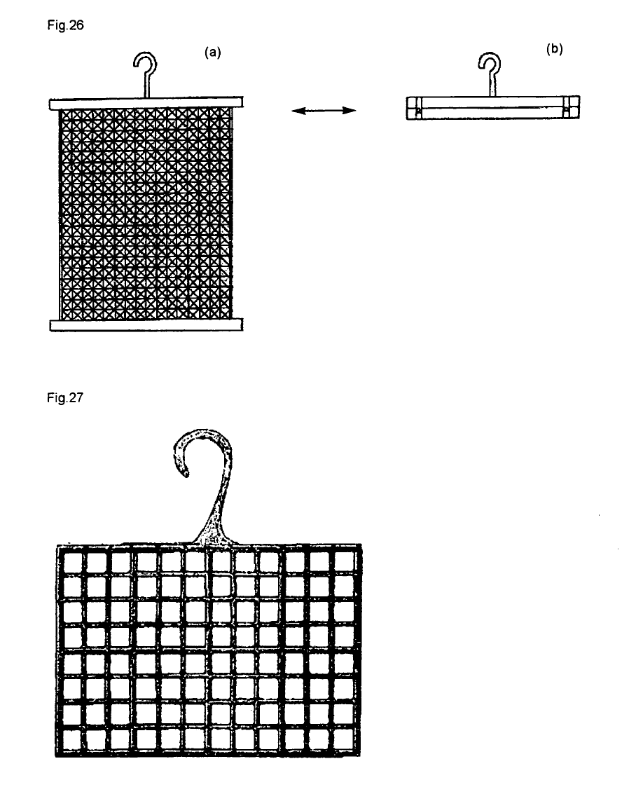

The arthropod controlling agent of the present invention can be formed into a suitable shape, and a housing part and a fixing part such as a hook are attached to the suitably shaped agent to make a hanging scroll that can be housed as needed (see FIG. 26). The hanging scroll may be hung on a curtain rail, a laundry pole, a pillar or the like with a fixing part such as a hook in such condition that the arthropod controlling agent of the present invention is spread (see FIG. 26(a)). The hanging scroll may be also housed in a housing part in such condition that the arthropod controlling agent of the present invention is folded (see FIG. 26(b)). In this case, the arthropod controlling agent of the present invention may be rolled up inside or outside the housing part.

A hook-type hanging tool may be attached to the lattice-like arthropod controlling agent of the present invention (see FIG. 27). The lattice-like arthropod controlling agent of the invention having a hook-type hanging tool may be hung on a curtain rail, a laundry pole, a pillar or the like with the hook-type hanging tool. Attachment of a hook-type hanging tool to the lattice-like arthropod controlling agent of the present invention is accomplished, for example, by joining the hook-type handing tool to the lattice-like arthropod controlling agent of the present invention via an attachment part, or by integrally molding the lattice-like arthropod controlling agent of the present invention and the hook-type handing tool. When the lattice-like arthropod controlling agent of the present invention and a hook-type handing tool are joined via an attachment part, the lattice-like arthropod controlling agent of the present invention is allowed to be replaceable.

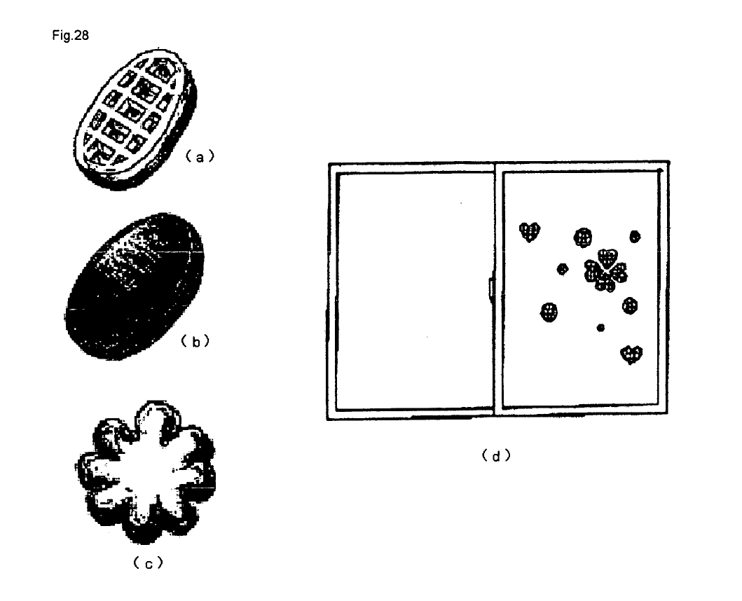

The arthropod controlling agent of the present invention can be in a suitably-shaped form to which a part for fixing on a plane is attached. The arthropod controlling agent of the present invention in this form can be fixed to a window, an interior wall of a room, a door, or the like via the part for fixing on a plane (see FIG. 28). Examples of the part for fixing on a plane include a seal and a sucking disk.

The arthropod controlling agent of the present invention can be used for controlling arthropods, for example, as exemplified below:

Hemiptera: Delphacidae such as Laodelphax striatellus, Nilaparvata lugens, Sogatella furcifera, etc.; Deltocephalidae such as Nephotettix cincticeps, Nephotettix virescens, etc.; Aphididae, Pentatomidae, Aleyrodidae, Coccoidea, Tingidae, Psyllidae, etc.;
Lepidoptera: Pyralidae such as Chilo suppressalis, Cnaphalocrocis medinalis, Plodia interpunctella, etc.; Noctuidae such as Spodoptera litura, Pseudaletia separata, agrotis segetum, etc.; Pieridae such as Pieris rapae, etc.; Tortricidae such as Adoxophyes honmai, Adoxophyes orana, etc.; Carposinidae; Lyonetiidae; Lymantriidae; Autographa; Agrotis spp. such as Agrotis segetum and Agrotis ipsolon; Helicoverpa spp.; Heliothis spp.; Plutella xylosttella, Parnara guttata, Tinea translucens, Tineola bisselliella, etc.;
Diptera: Culcidae such as Culex pipiens pallens, Culex tritaeniorhynchus, Culex quinquefasciatus, Culex pipens molestus, etc.; Aedes spp. such as Aedes aegypti, Aedes albopictus, etc.; Armigeres such as Armigeres subalbatus; Anopheles such as Anopheles sinensis, Anopheles minimus, Anopheles gambiae, etc.; Stomoxys calcitrans; Ceratopogonidae; Chironomidae; Muscidae such as Musca domestica, Muscina stabulans, etc.; Calliphoridae; Sarcophagidae; Anthomyiidae such as Delia platura, Fannia canicularis, Delia antiqua, etc.; Tephritidae; Drosophilidae; Psychodidae such as Clogmia albipunctata; Simuliidae; Tabanidae, etc.;
Coleoptera: corn root worms such as Diabrotica virgifera virgifera, Diabrotica undecimpunctata howardi, etc.; Scarabaeidae such as Anomala cuprea, Anomala rufocuprea, etc.; Curculionidae such as Sitophilus zeamais, Lissorhoptrus oryzophilus, Anthonomus grandis, Callosobruchuys chienensis, etc.; Tenebrionidae such as Tenebrio molitor, Tribolium castaneum, etc.; Chrysomelidae such as Oulema oryzae, Phylltreta nemorum, Aulacophora femoralis, etc.; Anobiidae; Epilachna spp. such as Epilachna vigintioctopunctata; Lyctidae; Bostrychidae; Cerambycidae; Paederus fuscipes, etc.;
Blattaria: Blattella germanica, Periplaneta fuliginosa, Periplaneta americana, Periplaneta brunnea, Blatta orientalis, etc.;
Thysanoptera: Thrips palmi, Frankliniella occidentalis, Thrips hawawiiensis, etc.;
Hymenoptera: Formicidae; Vespidae; Bethylidae; Tenthredimidae such as Athalia rosae, etc.;
Orthoptera: Gryllotalpidae, Acrididae, etc.;
Shiphonaptera: Pulex irritans, Ctenocephalides felis, etc.;
Anoplura: Pediculus humanus, Phthirus pubis, Haematopinus eurysternus, etc.;
Isoptera: Reticulitermes speratus, Coptotermes formosanus, etc.;
Acarina: Epidermoptidae such as Dermatophagoides farinae, Dermatophagoides ptrenyssnus, etc.; Acaridae such as Tyrophagus putrescentiae, Aleuroglyphus ovatus, etc.; Glycyphagidae such as Glycyphagidae privatus, Glycyphagidae domesticus, Glycyphagidae destructor, etc.; Cheyletidae such as Cheyletus malaccensis, Cheyletus malaccesis, etc.; Tarsonemidae; Chortoglyphidae; Haplochthoniidae; Tetranychidae; Dermanyssidae such as Ornithonyssus bacoti, Ornithonyssus sylvairum, Dermanyssus gallinae, etc.; Ixodidae such as Haemaphysalis longicornis, Rhipicephalus sanguineus, Boophilus microplus, etc.; Tetranychus urticae, Tetranychus kanzawai, Panonychus citri, Panonychus ulmi, etc.

The arthropod controlling agent of the present invention is useful for controlling bloodsucking arthropods, in particular, mosquitoes (e.g. Culicidae such as Culex pipens pallens, Culex quinquefasciatus, Culex pipens molestus, Culex tritaeniorhynchus, etc.; Aedes spp. such as Aedes albopictus, Aedes aegypti, Armigeres subalbatus, etc.; and Anopheles such as Anopheles sinensis, Anopheles minimus, Anopheles gambiae, etc.).

### EXAMPLES

The present invention will be further illustrated in detail by reference to Production Examples and Test Examples. However, the present invention is not limited to these Examples.

### Production Example 1

Twenty-eight parts by weight of an ethylene-methyl methacrylate copolymer (the proportion of methyl methacrylate in the copolymer: 25% by weight, trade name: ACRYFT WK 307, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Thirty-three parts by weight of the pellet and 67 parts by weight of a pellet of a linear low-density polyethylene (a homopolymer of ethylene) were mixed and kneaded to obtain a kneaded mixture.

Next, the kneaded mixture was molded with a die by an injection molding machine to obtain a lattice-like mesh sheet having a length of 10.9 cm, a width of 7.9 cm and a thickness of 4.6 mm and having 5.6 mm by 5.25 mm square holes (opening rate: 65%, see FIG. 7) (hereinafter referred to as the arthropod controlling agent (1) of the present invention).

### Production Example 2

Eighteen parts by weight of an ethylene-methyl methacrylate copolymer (the proportion of methyl methacrylate in the copolymer: 18% by weight, trade name: ACRYFT WH 303, Sumitomo Chemical Co., Ltd.) and 2 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Twenty parts by weight of the pellet and 80 parts by weight of a pellet of a linear low-density polyethylene (a homopolymer of ethylene) were mixed and kneaded to obtain a kneaded mixture.

Next, the kneaded mixture was extruded with a profile die for net-molding by an extruder to obtain a cylindrical body having a diameter of about 7 cm which was made of a net with an approximately diamond-shaped mesh of about 5 mm on each side (the diameter of a filament forming the net: about 0.83 mm, opening rate: 70%). The cylindrical body was cut into 20 cm length to obtain an arthropod controlling agent of the present invention (hereinafter referred to as the arthropod controlling agent (2) of the present invention).

### Production Example 3

Ninety-five parts by weight of an ethylene-methyl methacrylate copolymer (the proportion of methyl methacrylate in the copolymer: 10% by weight, trade name: ACRYFT WD 301, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Next, the pellet was kneaded. The obtained kneaded mixture was extruded with a profile die for net-forming by an extrusion molding machine to obtain a cylindrical body having a diameter of about 7 cm which was made of a net with an approximately diamond-shaped mesh of about 5 mm on each side (the diameter of a filament forming the net: about 0.83 mm, opening rate: 70%). The cylindrical body was cut into 10 cm length to obtain an arthropod controlling agent of present the invention (hereinafter referred to as the arthropod controlling agent (3) of the present invention).

### Production Example 4

Twenty-eight parts by weight of an ethylene-methyl methacrylate copolymer (the proportion of methyl methacrylate in the copolymer: 25% by weight, trade name: ACRYFT WK 307, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Thirty-three parts by weight of the pellet and 67 parts by weight of a pellet of a linear low-density polyethylene (a homoplymer of ethylene) were mixed and kneaded to obtain a kneaded mixture.

Next, the kneaded mixture was extruded and drawn with a profile die for net-forming by an extrusion molding machine to obtain a cylindrical body having a diameter of about 7 cm which was made of a net with an approximately diamond-shaped mesh of about 5 mm on each side (the diameter of a filament forming the net: about 0.83 mm, opening rate: 82%). The cylindrical body was cut into 20 cm length to obtain an arthropod controlling agent of the present invention (see FIG. 1, hereinafter referred to as the arthropod controlling agent (4) of the present invention).

### Production Example 5

Forty-five parts by weight of an ethylene-methyl methacrylate copolymer (the proportion of methyl methacrylate in the copolymer: 18% by weight, trade name: ACRYFT WH 303, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Fifty parts by weight of the pellet and 50 parts by weight of a pellet of a linear low-density polyethylene (a homoplymer of ethylene) were mixed and kneaded to obtain a kneaded mixture.

Next, the kneaded mixture was extruded and drawn with a profile die for net-forming by an extrusion molding machine to obtain a cylindrical body having a diameter of about 7 cm which was made of a net with an approximately diamond-shaped mesh of about 5 mm on each side (the diameter of a filament forming the net: about 0.83 mm, opening rate: 82%). The cylindrical body was cut into 20 cm length to obtain an arthropod controlling agent of the present invention (see FIG. 1, hereinafter referred to as the arthropod controlling agent (5) of the present invention).

### Production Example 6

Twenty-eight parts by weight of an ethylene-methyl methacrylate copolymer (the proportion of methyl methacrylate in the copolymer: 25% by weight, trade name: ACRYFT WK 307, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Thirty-three parts by weight of the pellet and 67 parts by weight of a pellet of a linear low-density polyethylene (a homoplymer of ethylene) were mixed and kneaded to obtain a kneaded mixture.

Next, the kneaded mixture was extruded with a profile die for net-forming by an extrusion molding machine to obtain a cylindrical body having a diameter of about 16 cm which was made of a net with an approximately diamond-shaped mesh of about 2.5 mm on each side (the diameter of a filament forming the net: about 0.5 mm, opening rate: 64%). The cylindrical body was cut to obtain a mesh sheet-like shaped arthropod controlling agent of the present invention having 40 cm in length×24 cm in width (see FIG. 2, hereinafter referred to as the arthropod controlling agent (6) of the present invention).

### Production Example 7

Eighteen parts by weight of an ethylene-methyl methacrylate copolymer (the proportion of methyl methacrylate in the copolymer: 18% by weight, trade name: ACRYFT WH 303, Sumitomo Chemical Co., Ltd.) and 2 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Twenty parts by weight of the pellet and 8 kg of a pellet of a linear low-density polyethylene (a homoplymer of ethylene) were mixed and kneaded to obtain a kneaded mixture.

Next, the kneaded mixture was extruded with a profile die for net-forming by an extrusion molding machine to obtain a cylindrical body having a diameter of about 16 cm which was made of a net with an approximately diamond-shaped mesh of about 2.5 mm on each side (the diameter of a filament forming the net: about 0.5 mm, opening rate: 64%). The cylindrical body was cut into 20 cm length to obtain an arthropod controlling agent of the present invention (see FIG. 1, hereinafter referred to as the arthropod controlling agent (7) of the present invention).

### Production Example 8

Ninety-five grams of an ethylene-methyl methacrylate copolymer (the proportion of methyl methacrylate in the copolymer: 10% by weight, trade name: ACRYFT WD-301, Sumitomo Chemical Co., Ltd.) and 5 g of 2,3,5,6-tetrafluoro-4-methoxymethylbenzyl 1R-trans-3-(1-propenyl(E/Z=1/8))-2,2-dimethylcyclopropanecarboxylate were mixed and then kneaded at 160° C. for 10 minutes to obtain 100 g of a kneaded mixture. Forty-two grams of the kneaded mixture was put in a flame with 150 mm×150 mm×2 mm, left at 150° C. for 2 minutes, pressurized at 150° C. and at 50 kg/cm² for 1 minute and then at 100 kg/cm² for 1 minute, and then cooled. The obtained molded product was taken out of the frame and cut in 150 mm×75 mm×2 mm to obtain an arthropod controlling agent of the present invention (hereinafter referred to as the arthropod controlling agent (8) of the present invention).

### Production Example 9

Ninety-five grams of an ethylene-methyl methacrylate copolymer (the proportion of methyl methacrylate in the copolymer: 10% by weight, trade name: ACRYFT WD-301, Sumitomo Chemical Co., Ltd.) and 5 g of 2,3,5,6-tetrafluoro-4-methylbenzyl 1R-trans-3-(1-propenyl (E/Z=1/8))-2,2-dimethylcyclopropanecarboxylate were mixed and then kneaded at 160° C. for 10 minutes to obtain 100 g of a kneaded mixture. Forty-two grams of the kneaded mixture was put in a flame with 150 mm×150 mm×2 mm, left at 150° C. for 2 minutes, pressurized at 150° C. and at 50 kg/cm² for 1 minute and then at 100 kg/cm² for 1 minute, and then cooled. The obtained molded product was taken out of the frame and cut in 150 mm×75 mm×2 mm to obtain an arthropod controlling agent of the present invention (hereinafter referred to as the arthropod controlling agent (9) of the present invention).

### Reference Example 1

Ninety-five parts by weight of an ethylene-methyl methacrylate copolymer (the proportion of methyl methacrylate in the copolymer: 25% by weight, trade name: ACRYFT WK 307, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Next, the pellet was kneaded. The obtained kneaded mixture was extruded with a profile die for net-forming by an extrusion molding machine to obtain a cylindrical body having a diameter of about 7 cm which was made of a net with an approximately diamond-shaped mesh of about 5 mm on each side (the diameter of a filament forming the net: about 0.83 mm, opening rate: 70%). The cylindrical body was cut into 10 cm length to obtain an arthropod controlling agent (hereinafter referred to as the comparative arthropod controlling agent (1)).

### Reference Example 2

Ninety-five parts by weight of an ethylene-methyl methacrylate copolymer (the proportion of methyl methacrylate in the copolymer: 25% by weight, trade name: ACRYFT WK 307, Sumitomo Chemical Co., Ltd.) and 5 parts by weight of 2,3,5,6-tetrafluoro-4-methoxymethylbenzyl 1R-trans-3-(1-propenyl(E/Z=1/8))-2,2-dimethylcyclopropanecarboxylate were melted and kneaded by a closed pressure kneader (Moriyama Seisakusho Co., Ltd.). The obtained kneaded mixture was hot-cut while being extruded by an extruder to obtain a pellet.

Next, the pellet was kneaded. The obtained kneaded mixture was extruded with a profile die for net-forming by an extrusion molding machine to obtain a cylindrical body having a diameter of about 7 cm which was made of a net with an approximately diamond-shaped mesh of about 5 mm on each side (the diameter of a filament forming the net: about 0.83 mm, opening rate: 82%). The cylindrical body was cut into 20 cm length to obtain an arthropod controlling agent (hereinafter referred to as the comparative arthropod controlling agent (2)).

### Reference Example 3

Ninety-five grams of an ethylene-methyl methacrylate copolymer (the proportion of methyl methacrylate in the copolymer: 20% by weight, trade name: ACRYFT WH 202, Sumitomo Chemical Co., Ltd.) and 5 g of 2,3,5,6-tetrafluoro-4-methoxymethylbenzyl 1R-trans-3-(1-propenyl(E/Z=1/8))-2,2-dimethylcyclopropanecarboxylate were mixed and then kneaded at 160° C. for 10 minutes to obtain 100 g of a kneaded mixture. Forty-two grams of the kneaded mixture was put in a flame with 150 mm×150 mm×2 mm, left at 150° C. for 2 minutes, pressurized at 150° C. and at 50 kg/cm² for 1 minute and then at 100 kg/cm² for 1 minute, and then cooled. The obtained molded product was taken out of the frame and cut in 150 mm×75 mm×2 mm to obtain an arthropod controlling agent (hereinafter referred to as the comparative arthropod controlling agent (3)).

### Reference Example 4

Ninety-five grams of an ethylene-methyl methacrylate copolymer (the proportion of methyl methacrylate in the copolymer: 20% by weight, trade name: ACRYFT WH 202, Sumitomo Chemical Co., Ltd.) and 5 g of 2,3,5,6-tetrafluoro-4-methylbenzyl 1R-trans-3-(1-propenyl(E/Z=1/8))-2,2-dimethylcyclopropanecarboxylate were mixed and then kneaded at 160° C. for 10 minutes to obtain 100 g of a kneaded mixture. Forty-two grams of the kneaded mixture was put in a flame with 150 mm×150 mm×2 mm, left at 150° C. for 2 minutes, pressurized at 150° C. and at 50 kg/cm² for 1 minute and then at 100 kg/cm² for 1 minute, and then cooled. The obtained molded product was taken out of the frame and cut in 150 mm×75 mm×2 mm to obtain an arthropod controlling agent (hereinafter referred to as the comparative arthropod controlling agent (4)).

### Test Example 1

The arthropod controlling agent (2) of the present invention was hung lengthwise from the center part of the ceiling in a testing room of about 5.8 m³ (base: 1.8 m×1.8 m, height: 1.8 m). The lower end of the arthropod controlling agent (2) of the present invention was about 156 cm from the floor. After 1 hour, 50 female imagoes of Aedes albopictus were released into the testing room. After further 10 minutes, the number of imagoes being knocked down in the testing room was counted. As a result, 43 imagoes were knocked down.

### Test Example 2

The arthropod controlling agent (3) of the present invention and the comparative arthropod controlling agent (1) were respectively hung lengthwise from the center parts of the ceilings in testing rooms of about 0.34 m³ (base: 0.7 m×0.7 m, height: 0.7 m). The lower ends of the arthropod controlling agent (3) of the present invention and the comparative arthropod controlling agent (1) were about 58 cm from the floors. As soon as the arthropod controlling agent (3) of the present invention or the comparative arthropod controlling agent (1) was hung in the testing room, 20 female imagoes of Culex pipiens pallens were released into the testing room. After further 30 minutes, the numbers of imagoes being knocked down in the respective testing rooms were counted.

The results are shown in Table 1.

TABLE 1

| | The number of Culex pipiens |
|---|---|
| Arthropod controlling agent | pallens knocked down |
| Arthropod controlling agent | 19 |
| (3) of the present invention | |
| Comparative arthropod | 0 |
| controlling agent (1) | |

### Test Example 3

The arthropod controlling agents (1), (4) and (6) of the present invention and the comparative arthropod controlling agent (2) were respectively hung lengthwise from the center parts of the ceilings in testing rooms of about 0.34 m³ (base: 0.7 m×0.7 m, height: 0.7 m). As soon as the arthropod controlling agents (1), (4) and (6) of the present invention and the comparative arthropod controlling agent (2) were hung in the respective testing rooms, 20 female imagoes of Culex pipiens pallens were released into the respective testing rooms. After further 30 minutes, the numbers of imagoes being knocked down in the respective testing rooms were counted.

The results are shown in Table 2.

TABLE 2

| | The number of Culex pipiens |
|---|---|
| Arthropod controlling agent | pallens knocked down |
| Arthropod controlling agent | 16 |
| (1) of the present invention | |
| Arthropod controlling agent | 20 |
| (4) of the present invention | |
| Arthropod controlling agent | 20 |
| (6) of the present invention | |
| Comparative arthropod | 0 |
| controlling agent (2) | |

### Test Example 4

The arthropod controlling agent (4) of the present invention was hung lengthwise from the center part of the ceiling in a testing room of about 5.8 m³ (base: 1.8 m×1.8 m, height: 1.8 m). The lower end of the arthropod controlling agent (4) of the present invention was about 100 cm from the floor. After 5 minutes, 50 female imagoes of Aedes albopictus were released into the testing room. After further 10 minutes, the number of imagoes being knocked down in the testing room was counted. As a result, 43 imagoes were knocked down.

### Test Example 5

The arthropod controlling agent (6) of the present invention was hung lengthwise from the center part of the ceiling in a testing room of about 28 m³ (base: 3.0 m×4.0 m, height: 2.3 m). The lower end of the arthropod controlling agent (6) of the present invention was about 120 cm from the floor. After 5 minutes, 50 female imagoes of Aedes albopictus were released into the testing room. After further 10 minutes, the number of imagoes being knocked down in the testing room was counted. As a result, 48 imagoes were knocked down.

### Test Example 6

One arthropod controlling agent (4) of the present invention was installed on a branch of a tree in a garden (about 12 m²) at 25 to 35° C. and gardening was carried out for about 1 hour every evening. As a result, the gardeners never had their blood sucked by mosquitoes or the like for 1 month after the installation of the arthropod controlling agent (4) of the present invention.

### Test Example 7

One arthropod controlling agent (4) of the present invention was installed on a laundry pole placed in a balcony (temperature: 25 to 35° C.) (see FIG. 3(a)). When the laundry was hung on the laundry pole to dry and then taken down from the pole in the balcony, the workers never had their blood sucked by mosquitoes or the like for about 1 month after the installation of the arthropod controlling agent (4) of the present invention. After that, when the arthropod controlling agent (4) of the present invention was removed from the balcony and the laundry was hung on the laundry pole to dry and then taken down from the pole in the balcony, the workers had bites by blood-sucking arthropods such as mosquitoes or the like.

### Test Example 8

The arthropod controlling agent (4) of the present invention was hung from the ceiling of a mosquito net of about 3.4 m³ (base: 1.5 m×1.5 m, height: 1.5 m). A cage (70 cm on each side) made of a metal in which a beagle dog was put was placed in the center of the mosquito net. Then, 50 female imagoes of Aedes albopictus were released into the mosquito net. After 6 hours, the number of imagoes being knocked down and the number of imagoes sucking the blood of the dog in the mosquito net were counted. As a result, 35 imagoes were knocked down and there was no Aedes albopictus sucking the blood. On the other hand, when the similar experiment was carried out in a mosquito net in which the arthropod controlling agent (4) of the present invention was not installed, there was no Aedes albopictus being knocked down and 26 imagoes of Aedes albopictus were sucking the blood.

### Test Example 9

The arthropod controlling agent (4) of the present invention to which a string and a fixing tool were attached was installed in an outdoor kennel as shown in FIG. 11 (left figure) and a beagle dog was raised in the kennel. As a result, the dog had no bite by blood-sucking arthropods such as mosquitoes or the like for a month after installation of the arthropod controlling agent (4) of the present invention.

### Test Example 10

The arthropod controlling agent (6) of the present invention is hung from the ceiling of a mosquito net of about 3.4 m³ (base: 1.5 m×1.5 m, height: 1.5 m). A cage (70 cm on each side) made of a metal in which a beagle dog is put is placed in the center of the mosquito net. Then, 50 female imagoes of Aedes albopictus are released into the mosquito net. After 6 hours, the number of imagoes being knocked down and the number of imagoes sucking the blood of the dog in the mosquito net are counted. As a result, it can be confirmed that the arthropod controlling agent (6) of the present invention shows sufficiently high arthropod-controlling effect.

### Test Example 11

The arthropod controlling agent (6) of the present invention to which a string and a fixing tool were attached was installed in an outdoor kennel as shown in FIG. 11 (left figure) and a beagle dog was raised in the kennel. As a result, the dog had no bite by blood-sucking arthropods such as mosquitoes or the like for 2 weeks after installation of the arthropod controlling agent (6) of the present invention.

### Test Example 12

The arthropod controlling agent (1) of the present invention was hung lengthwise from the center part of the ceiling in a testing room of about 5.8 m³ (base: 1.8 m×1.8 m, height: 1.8 m). The lower end of the arthropod controlling agent (1) of the present invention was about 156 cm from the floor. After 5 minutes, 50 female imagoes of Aedes albopictus were released into the testing room. After further 60 minutes, the number of imagoes being knocked down in the testing room was counted. As a result, 35 imagoes were knocked down.

### Test Example 13

The arthropod controlling agent (1) of the present invention was attached to the outside of a cage (70 cm on each side) made of a metal in which a beagle dog was put. The cage was installed in the center of a mosquito net of about 3.4 m³ (base: 1.5 m×1.5 m, height: 1.5 m). Then, 50 female imagoes of Aedes albopictus were released into the mosquito net. After 6 hours, the number of imagoes being knocked down and the number of imagoes sucking the blood of the dog in the mosquito net were counted. As a result, 25 imagoes were knocked down and only an imago was sucking the blood. On the other hand, when the similar experiment was carried out in a mosquito net in which the arthropod controlling agent (1) of the present invention was not installed, there was no imago being knocked down and 26 imagoes of Aedes albopictus were sucking the blood.

### Test Example 14

The arthropod controlling agents (6) of the present invention are placed at two points in a clothes box (725 mm in length×427 mm in width×158 mm in height). The clothes box is left in a room at 25±2° C. After 1 week, bags (size: 4.5 cm×4.5 cm) made of cotton cloth (thickness: 0.2 mm) and containing 10 to 15 eggs of Tineola bisselliella are each placed near the arthropod controlling agents (6) of the present invention in the clothes box. After left for 1 week, the bags containing the eggs of Tineola bisselliella are opened and the number of surviving eggs and the number of dead eggs are counted. As a result, it can be confirmed that the arthropod controlling agent (6) of the present invention shows arthropod-controlling effect.

### Test Example 15

The arthropod controlling agents (1) of the present invention are placed at two points in a clothes box (725 mm in length×427 mm in width×158 mm in height). The clothes box is left in a room at 25±2° C. After 1 week, bags (size: 4.5 cm×4.5 cm) made of cotton cloth (thickness: 0.2 mm) and containing 10 to 15 eggs of Tineola bisselliella are each placed near the arthropod controlling agents (1) of the present invention in the clothes box. After left for 1 week, the bags containing the eggs of Tineola bisselliella are opened and the number of surviving eggs and the number of dead eggs are counted. As a result, it can be confirmed that the arthropod controlling agent (1) of the present invention shows arthropod-controlling effect.

### Test Example 16

The right arm of an examinee whose both arms are exposed was put through the inside of the cylindrical arthropod controlling agent (4) of the present invention and the agent is attached to exposed skin near the wrist. The examinee takes a walk with a dog for 1 hour outdoors (air temperature: about 30° C.). Then, the examinee is checked for the presence of bites by blood-sucking arthropods such as mosquitoes or the like. On the other hand, an examinee without the arthropod controlling agent of the present invention takes a walk with a dog for 1 hour under about the same weather conditions and then is checked for the presence of bites by blood-sucking arthropods such as mosquitoes or the like. As a result, it can be confirmed that the arthropod controlling agent (4) of the present invention shows arthropod-controlling effect.

### Test Example 17

The arthropod controlling agent (4) of the present invention is cut into 10 cm in length×9 cm in width and then attached to a portion within 30 cm from the connection part between the lead and the collar of a dog. The dog is taken for a walk for 1 hour outdoors (air temperature: about 30° C.) and then checked for the presence of bites by blood-sucking arthropods such as mosquitoes or the like. On the other hand, a dog without the arthropod controlling agent of the present invention is taken for a walk for 1 hour under about the same weather conditions and then checked for the presence of bites by blood-sucking arthropods such as mosquitoes or the like. As a result, it can be confirmed that the arthropod controlling agent (4) of the present invention shows arthropod-controlling effect.

### Test Example 18

The arthropod controlling agent (6) of the present invention is cut into 10 cm in length×24 cm in width and wound around the right wrist of an examinee whose both arms were exposed. The examinee takes a walk with a dog for 1 hour outdoors (air temperature: about 30° C.) and then checked for the presence of bites by blood-sucking arthropods such as mosquitoes or the like. On the other hand, an examinee without the arthropod controlling agent of the present invention takes a walk with a dog for 1 hour under about the same weather conditions and then checked for the presence of bites by blood-sucking arthropods such as mosquitoes or the like. As a result, it can be confirmed that the arthropod controlling agent (6) of the present invention shows arthropod-controlling effect.

### Test Example 19

The arthropod controlling agents (8) and (9) of the present invention and the comparative arthropod controlling agents (3) and (4) were respectively hung lengthwise from the center parts of the ceilings in testing rooms of about 0.34 m³ (base: 0.7 m×0.7 m, height: 0.7 m). As soon as the arthropod controlling agents (8) and (9) of the present invention and the comparative arthropod controlling agents (3) and (4) were hung in the respective testing rooms, 10 female imagoes of Culex pipiens pallens were released into the respective testing rooms. After 30 minutes, the numbers of imagoes being knocked down in the testing rooms were counted.

The results are shown in Table 3.

TABLE 3

| | The number of Culex pipiens |
|---|---|
| Arthropod controlling agent | pallens knocked down |
| Arthropod controlling agent | 9 |
| (8) of the present invention | |
| Arthropod controlling agent | 8 |
| (9) of the present invention | |
| Comparative arthropod | 1 |
| controlling agent (3) | |
| Comparative arthropod | 1 |
| controlling agent (4) | |

The arthropod controlling agent of the present invention rapidly exerts its efficacy against arthropods and retains the efficacy for a long time, and therefore it is suitable for controlling arthropods.

What is claimed is:

1. An arthropod controlling agent which comprises an ester compound represented by the following formula (1): 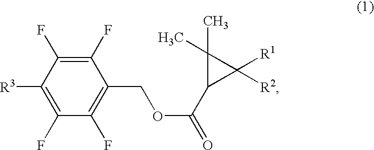
wherein
R¹ denotes a hydrogen atom or methyl,
R² denotes methyl or CH═CR²¹R²² wherein R²¹ and R²² independently denote a hydrogen atom or methyl, and
R³ denotes a hydrogen atom, methyl or methoxymethyl, and said ester compound is supported on a polyolefin type resin, wherein the polyolefin type resin contains carboxylic acid ester monomer units in an amount of 1 to 10% by weight based on the entire arthropod controlling agent.

2. The arthropod controlling agent according to claim 1, wherein the weight ratio of the ester compound represented by the formula (1) and the carboxylic acid ester monomer units is in the range from 3:1 to 1:3.

3. The arthropod controlling agent according to claim 1 or 2, which contains 0.1 to 20% by weight of the ester compound represented by the formula (1) based on entire amount of the arthropod controlling agent.

4. The arthropod controlling agent according to claim 1, wherein the polyolefin type resin is a polyethylene type resin.

5. The arthropod controlling agent according to claim 1, wherein the carboxylic acid ester monomer is unsaturated carboxylic acid ester or vinyl carboxylate.

6. The arthropod controlling agent according to claim 1, wherein the carboxylic acid ester monomer is methyl acrylate, methyl methacrylate or vinyl acetate.

7. The arthropod controlling agent according to claim 1, wherein the carboxylic acid ester monomer is methyl methacrylate.

8. The arthropod controlling agent according to claim 1, wherein the polyolefin type resin is a resin containing an ethylene-methyl methacrylate copolymer.

9. The arthropod controlling agent according to claim 1, wherein the polyolefin type resin is a polymer blend of polyethylene and an ethylene-methyl methacrylate copolymer.

10. The arthropod controlling agent according to claim 1, which comprises the ester compound represented by the formula (1) wherein
R¹ denotes a hydrogen atom,
R² denotes CH═CR²¹R²²wherein R²¹ and R²² independently denote a hydrogen atom or methyl, and
R³ denotes a hydrogen atom, methyl or methoxymethyl.

11. The arthropod controlling agent according to claim 1, wherein the ester compound represented by the formula (1) is selected from the group consisting of
2,3,5,6-tetrafluoro-4-methoxymethylbenzyl 3-(1-propenyl)-2,2-dimethylcyclopropanecarboxylate,
2,3,5,6-tetrafluoro-4-methylbenzyl 3-(1-propenyl)-2,2-dimethylcyclopropanecarboxylate,
2,3,5,6-tetrafluoro-4-methoxymethylbenzyl 3-(2-methyl-1-propenyl)-2,2-dimethylcyclopropanecarboxylate,
2,3,5,6-tetrafluoro-4-methoxymethylbenzyl 2,2,3,3-tetramethylcyclopropanecarboxylate,
2,3,5,6-tetrafluoro-4-methylbenzyl 2,2,3-trimethylcyclopropanecarboxylate,
2,3,5,6-tetrafluoro-4-methoxymethylbenzyl 1R-trans-3-(1-propenyl)-2,2-dimethylcyclopropanecarboxylate,
2,3,5,6-tetrafluoro-4-methylbenzyl 1R-trans-3-(1-propenyl)-2,2-dimethylcyclopropanecarboxylate,
2,3,5,6-tetrafluoro-4-methoxymethylbenzyl 1R-trans-3-(2-methyl-1-propenyl)-2,2-dimethylcyclopropanecarboxylate,
2,3,5,6-tetrafluoro-4-methylbenzyl 1R-trans-2,2,3-trimethylcyclopropanecarboxylate,
2,3,5,6-tetrafluoro-4-methoxymethylbenzyl 1R-trans-3-(1-propenyl(E/Z=1/8))-2,2-dimethylcyclopropanecarboxylate, and
2,3,5,6-tetrafluoro-4-methylbenzyl 1R-trans-3-(1-propenyl(E/Z=1/8))-2,2-dimethylcyclopropanecarboxylate.

12. The arthropod controlling agent according to claim 1, wherein one or more opening parts are present and the opening rate is 50 to 90%.

13. The arthropod controlling agent according to claim 1, which is effective against mosquitoes.

14. A method for controlling arthropods which comprises installing the arthropod controlling agent according to claim 1 in a place where arthropods inhabit or invade.

15. The method according to claim 14, wherein the place where arthropods inhabit or invade is the entrance of a house, a garden, a living room, a balcony and a porch, or the inside of a drawer or a closet.

16. The method according to claim 14, wherein the place where arthropods inhabit or invade is a place where a domestic animal or a pet is kept.

17. A method for controlling arthropods which comprises attaching the arthropod controlling agent according to claim 1 to a part of the body surface of a warm-blooded animal.
